(19) United States
(12) Patent Application Publication
(10) Pub. No.: US 2012/0111472 A1
(43) Pub. Date: May 10, 2012

(54) DEVICES AND METHODS FOR APPLYING ADHESIVE LINER-LESS SECURITY LABELS TO ARTICLES

(75) Inventors: Israel Vega, Brea, CA (US); Jack L. Clinkenbeard, Yorba Linda, CA (US); George Allen, Irvine, CA (US)

(73) Assignee: LABEL AIRE, INC., Fullerton, CA (US)

(21) Appl. No.: 13/289,232

(22) Filed: Nov. 4, 2011

Related U.S. Application Data
(60) Provisional application No. 61/410,845, filed on Nov. 5, 2010.

(51) Int. Cl. B65C 3/24; G05G 15/00; B65C 9/26

(52) U.S. Cl. 156/64; 156/387; 156/350; 156/356

(57) ABSTRACT

A liner-less seal application system is programmed to generate a real time seal, the serial number of which is data-matched with product label data on an approaching article. The image is printed onto the adhesive surface of the sealing tape. A vacuum drive belt has both low and high vacuum sections to assist in moving the sealing tape along a vacuum drive belt toward the print head. The real-time seal is printed while the belt drive indexes the tape, and the cutting action is done while the system collects data and the belt drive is stationary. There is only one stepper motor employed to drive the vacuum belt. The vacuum belt drive pulls the tape from the unwind assembly and feeds the tape through the print head and onto the vacuum drum applicator. A perforator device bursts perforation across the round element of the seal image, as an anti-tampering measure.

This application claims the benefit under 35 U.S.C. 119(e) of the filing date of Provisional U.S. Application Ser. No. 61/410,845, entitled Devices and Methods for Applying Adhesive Liner-Less Security Labels to Articles, filed on Nov. 5, 2010, which application is expressly incorporated herein by reference, in its entirety.

### Field of the Invention

This invention relates generally to label applicators and more particularly, to label applicators and methods for applying adhesive liner-less labels and sealing tape to passing articles.

### BACKGROUND OF THE INVENTION

Label applicators for applying pressure-sensitive adhesive-backed labels to articles passing the applicator on a conveyor are well known. Label applicators of this general type are shown in commonly assigned U.S. Pat. No. 4,255,220, issued to Kucheck et al., U.S. Pat. No. 4,844,771, issued to Crankshaw et al., and U.S. Pat. No. 5,421,948, issued to Crankshaw et al, for example. Other prior art references of interest include Published U.S. Patent Application No. 2003/0121593, U.S. Pat. No. 5,935,361 to Takahashi et al., U.S. Pat. No. 5,643,395 to Hinton, U.S. Pat. No. 5,039,374 to Winter, Published U.S. Patent Application No. US 2003/0121593, International Publication No. WO 2005/035263, International Publication No. 2006/016823, and International Publication No. 2009/120096. All of the aforementioned patents and published patent applications are herein expressly incorporated by reference, in their entirety. Typically, such labeling apparatus comprise a supply of adhesive-backed labels carried upon an elongate web of release material which is fed from a supply reel to a take-up reel, with the label applicator disposed between the two reels.

In some applications, it is presently desired to utilize pressure-sensitive adhesive-backed labels which are not carried on such a web, in order to eliminate the need to dispose of the waste web collected on the take-up reel, once the labels thereon have been dispensed. In particular, it is becoming increasingly common for governments to impose punitive fees for disposing of waste generated during manufacturing processes, and there is also a cost savings if materials such as the carrier web can be eliminated. Accordingly, companies such as Catchpoint, Inc., having a U.S. office in Piscataway, N.J., have developed liner-less labels, which are described at its website, www.catchpointlabels.com. Such labels are also described, for example, in U.K. Patent Application No. 0501369.3, filed on Jan. 22, 2005 and entitled Improvements to Labels and Application Apparatus therefor, herein expressly incorporated by reference, in its entirety.

The assignee of the present application, Label-Aire, Inc., is also the assignee of co-pending U.S. application Ser. No. 11/809,793, entitled Devices for Applying Pressure-Sensitive Adhesive Liner-Less Labels to Articles, filed on Jun. 1, 2007, and published as U.S. Published Application No. 2007-0295449. This application is herein expressly incorporated by reference, in its entirety. This prior application discloses a system and methods for applying liner-less labels to articles using an operating regime, wherein the perforated labels are separated from one another using an innovative approach involving employing a coordinated drive roller and vacuum belt system for applying a distally directed tensile force (i.e. a tensile force applied in the same direction as the direction of travel of the label feedpath) at an appropriate time for separating the connected labels from one another reliably and without tearing the labels.

In certain industries, such as the meat packing industry, it is important to be able to seal containers with Government approved security seals. Existing methods use paper labels which are supplied to the processing company in liner-backed roll form. This presents a security issue in regard to transport, storage, use and wearability of the label. No data match between seal and actual carton product is achievable. A liner-less approach such as that taught in the aforementioned '449 publication is not appropriate for this use, because the adhesive backing the labels is too mild What is needed is a liner-less system wherein regulatory security data and other information is printed on the labels in real time, automatically with enhanced auditing and data matching capabilities, and further wherein a strong seal is created to ensure that it is tamper-evident.

These new label types are not amenable to application using existing label applicator systems and processes. Accordingly, what is needed are new or modified systems and processes for efficiently and reliably separating and dispensing these types of labels.

### SUMMARY OF THE INVENTION

The present invention addresses the issues noted above, and is designed to print and place liner-less seals and labels and other regulatory security data in real time, automatically, with enhanced auditing and data matching capabilities. Articles, such as cartons, are closed in a conventional method using strapping or gluing. The inventive system comprises four major interconnecting modules. These include a liner-less tape print and apply unit, a seal printing unit, a carton centering and conveying system, and a PC interface and control elements.

The system accepts articles from an accumulating conveyor via a gate. Articles are presented end on so that the main panel, i.e. the end panel of the article already having a label displaying the product/weight and barcode, which includes field defining data, product details, carton size, type, and the like, leads.

From this data, the system is programmed to generate a real-time seal—the serial number of which is data-matched with the product label data. The image is printed in the required position (to suit that article) onto the adhesive surface of the seal tape. The required tape length is fed from the liner-less applicator out onto a vacuum drum unit, which contacts the center of the leading end of the article. The seal tape is laid onto the surface with moderate pressure, to achieve a viable bond of the adhesive in the article surface fibers. The gate unit allows an article onto the main conveyor, which in turn transfers the article through the system at a higher speed than the accumulating conveyor. This generates a gap between articles at the accumulating conveyor, allowing a data label for scanning with a barcode reader. The vacuum drum wipes the tape around the end and top panels of the article, and a roller device wipes the label around the bottom corner of the article. The sealed article travels through the machine and exits. The tape printed information is verified by a second barcode reader while the article exits the system.

Focusing more particularly now on the liner-less applicator portion of the system, the system is programmed to generate a real time seal, the serial number of which is data-matched with the product label data. The image is printed in the required position (to suit the article being sealed), onto the adhesive surface of the seal tape. A rubber coated idler roller incorporates a one-way bearing. The bearing and the rubber roller overcomes the pull from the unwind assembly, which prevents the tape from running backwards. The plasma coated idler roller provides a high release surface, where the tape adhesive side contacts it. The vacuum drive belt has three vacuum sections. The high-vacuum sections are adjacent to the cutter and a low-vacuum section is just below the print head. The vacuum sections are used to pull the tape against the high friction endless belt. This action generates a friction force to un-spool the tape, to hold down the tape during the cutting action, and to present a flat-smooth surface while the seal is printed. The real-time seal is printed while the belt drive indexes the tape, and the cutting action is done while the system collects data and the belt drive is stationary. There is only one stepper motor employed to drive the vacuum belt. The vacuum belt drive pulls the tape from the unwind assembly and feeds the tape through the print head and onto the vacuum drum applicator. A perforator device bursts perforation across the round element of the seal image. This is to apply a weak point on which the seal will break if tampered with.

An important aspect of the invention is that the seals are produced and applied fully automatically, with no operator intervention. Security and auditing of the printed seal and applying process are paramount.

More particularly, there is provided in one embodiment of the invention a label application system for applying liner-less labels comprising adhesive tape to passing articles on a conveyor. The system comprises a dispenser for dispensing adhesive tape, and a vacuum drive belt unit comprising a drive belt onto which the adhesive tape dispensed by the dispenser is received and retained. The adhesive tape is received onto the drive belt so that its non adhesive side contacts the drive belt and its adhesive side faces up, the adhesive tape being retained on the drive belt by vacuum fans beneath the drive belt. A print head is provided for printing information on the adhesive side of the tape as it passes adjacent to the print head. A cutter is provided for cutting the tape, and an applicator is provided for applying the printed, cut portion of tape onto an article passing on the conveyor.

The system further comprises a controller, which includes a processor for determining the information to be printed on the tape, wherein the information comprises a real-time seal to ensure that the passing article is tamper-proof A reader, such as a barcode reader, is located adjacent to the applicator, for reading product labels on articles to be sealed as they approach the applicator on the conveyor, and transmitting the read information on the product labels to the processor. As a security measure, a perforator is provided for perforating or delaminating the tape in the printed area, thereby weakening the tape to cause the printed portion of the tape to break if tampered with.

An advantageous feature of the system is that the vacuum drive belt comprises a relatively high vacuum section and a relatively low vacuum section, for providing forward control of the tape along its feedpath. The relatively high vacuum section on the vacuum drive belt is disposed adjacent to the cutter, and the relatively low vacuum section on the vacuum drive belt is disposed adjacent to the print head.

A quality control feature of the present invention is the provision of a second reader downstream of the reader, for verifying that the information printed on the tape disposed on a passing article matches the information on the product label disposed on the same article. Wipers are provided, as a part of the applicator system, for ensuring that the printed, cut portion of tape is applied securely to multiple sides of the passing article.

In another aspect of the present invention, there is provided a label application system for applying liner-less security seals comprising adhesive tape to passing articles on a conveyor. The system comprises a dispenser for dispensing adhesive tape, and a drive belt onto which the adhesive tape dispensed by the dispenser is received and retained. The adhesive tape is received onto the drive belt so that its non adhesive side contacts the drive belt and its adhesive side faces up. A controller having a processor is provided for directing the operation of the system. A reader is adjacent to the conveyor for reading a product label disposed on a face of an article to be sealed, and transmitting the read information to the processor. The system comprises a print head for printing information on the adhesive side of the tape as it passes adjacent to the print head. The system further comprises a cutter for cutting the tape, and an applicator for applying the printed, cut portion of tape onto an article passing on the conveyor.

Operationally, the information applied by the print head onto the tape is received from the processor and derived from the information read by the reader from the product label. The applicator comprises a vacuum drum applicator, and in a current embodiment of the invention, the reader comprises a barcode reader. In order to enhance the security of the seal, the system comprises a perforator for perforating or delaminating the tape in the printed area, thereby weakening the tape to cause the printed portion of the tape to break if tampered with. A quality control feature is included as well, comprising a second reader downstream of the reader, for verifying that the information printed on the tape disposed on a passing article matches the information on the product label disposed on the same article.

In yet another aspect of the invention, there is disclosed method of applying tamper-resistant seals to passing articles, which comprises a step of advancing a length of adhesive tape along a feedpath onto a vacuum drive belt. The provided tape has an adhesive side and a non-adhesive side, wherein the adhesive side contacts the vacuum drive belt and the non-adhesive side faces upwardly. Another step of the inventive method comprises reading information contained on a product label disposed on an article approaching a seal applicator and transmitting that information to a processor. Additional steps include using the information from the product label obtained by the reading step to cause the processor to generate information specific to the approaching article and to transmit that information to a print-head, as well as using the print head to apply the specific information generated by the processor to a portion of the adhesive side of the tape as it passes adjacent to the print head. The printed portion of the tape is cut from a remaining length of tape, and the cut portion is fed to an applicator. Using the provided applicator, the cut and printed portion of the tape is applied to the approaching article.

A further step of the inventive method comprises perforating portions of the cut and printed portion of tape, on its printed region, to weaken it so that any tampering with the seal will cause the seal to break and thus comprise visible evidence of the tampering. To enhance operational control of the security tape, by assisting in moving the tape forwardly along the drive belt, a step of applying differential levels of vacuum pressure to different regions of the vacuum drive belt is performed. This step of applying differential levels of vacuum pressure may further comprise applying a relatively high level of vacuum pressure adjacent to a cutter for performing the cutting step and applying a relatively low level of vacuum pressure adjacent to the print head. As a quality control measure, the inventive method further comprises a step of reading the information applied to the seal by the print head after the sealed article has passed further downstream on the conveyor, and transmitting the read information to the processor to ensure that it matches the information originally read on the product label during the first reading step.

The invention, together with additional features and advantages thereof, may be best understood by reference to the following description taken in conjunction with the accompanying illustrative drawings. In these accompanying drawings, like reference numerals designate like parts throughout the figures.

### BRIEF DESCRIPTION OF THE DRAWINGS

FIG. 1 is a schematic view of a liner-less labeling system constructed in accordance with the principles of the present invention;

FIG. 2 is an isometric view of the applicator portion of the system of FIG. 1;

FIG. 3 is a plan view of the applicator portion of FIG. 2;

FIG. 4 is an end view of the applicator portion of FIGS. 2 and 3; and

FIG. 5 is a top view of the applicator portion of FIGS. 2-4.

### DETAILED DESCRIPTION OF THE INVENTION

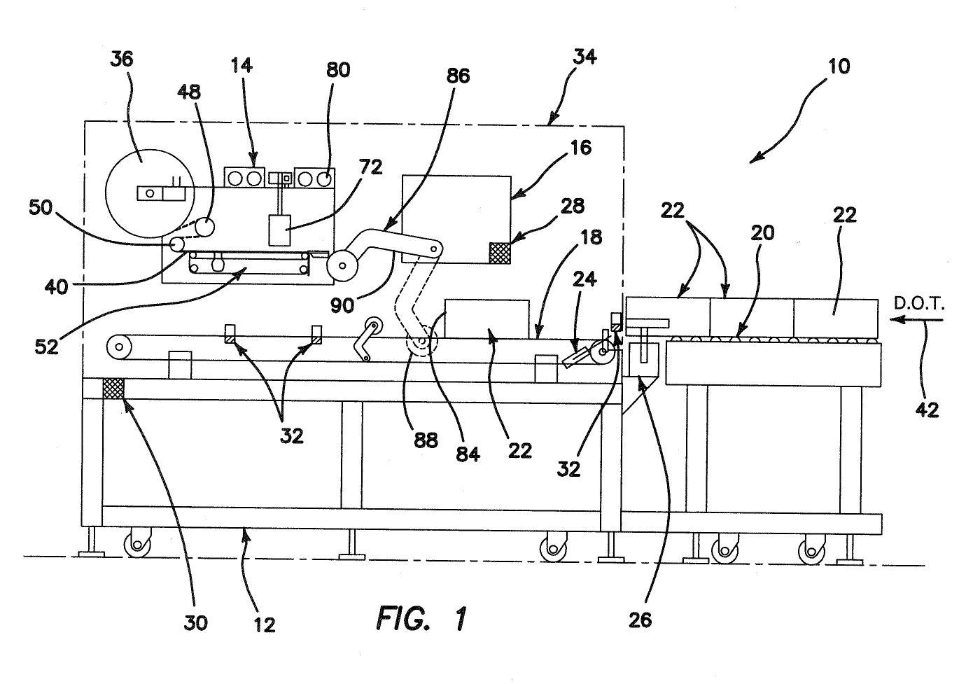

Referring now to the drawings, wherein like reference numerals designate identical or corresponding parts throughout the several views and embodiments, there is shown in FIG. 1 a liner-less label application system 10. The system 10 comprises a main frame 12, a liner-less label applicator 14, an applicator unit 16, a main conveyor 18, and an accumulating conveyor 20. Articles 22 to be labeled move along the accumulating conveyor 20 until they are stopped by a gate 24 and organized by an article centering device 26. In a preferred embodiment, the system has a capacity for sealing up to twenty articles per minute.

A first barcode reader 28 is disposed on the applicator unit 16, while a second barcode reader 30 is disposed on the main frame 12, adjacent to a distal terminus of the main conveyor 18. First, second, and third article sensors 32 are disposed in spaced fashion along the main conveyor 18, as shown. A suitable enclosure, such as enclosure 34 fabricated of a transparent thermoplastic material, such as PLEXIGLASS®, a polycarbonate, or other suitable materials, may be provided, if desired. Such a stainless steel and polycarbonate enclosure affords seal integrity and security, as well as moisture control.

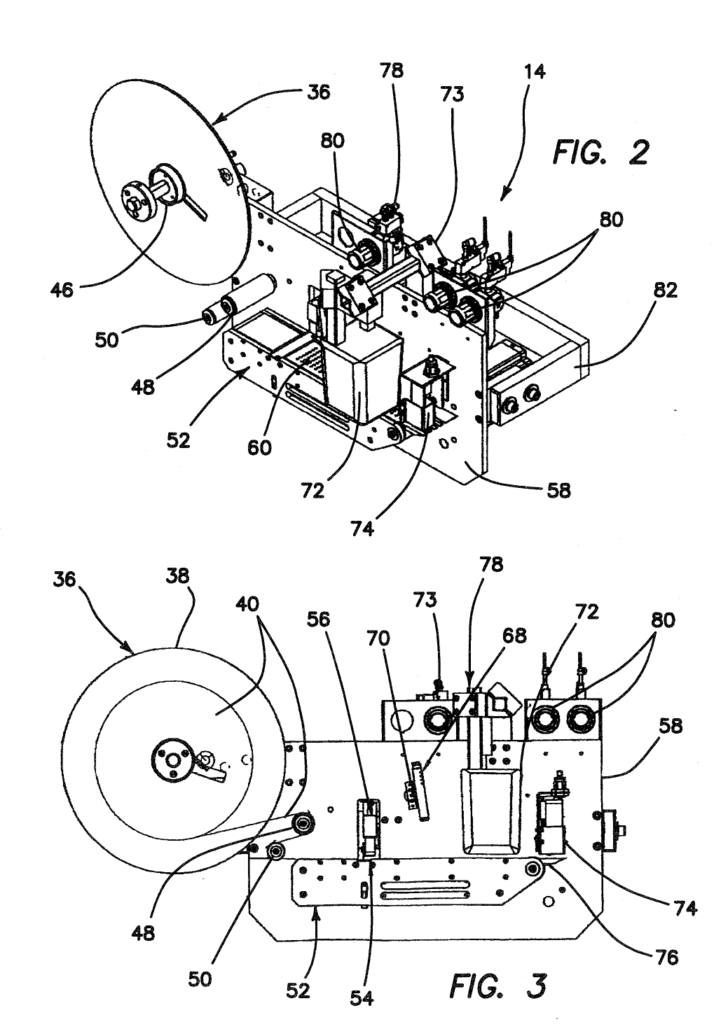

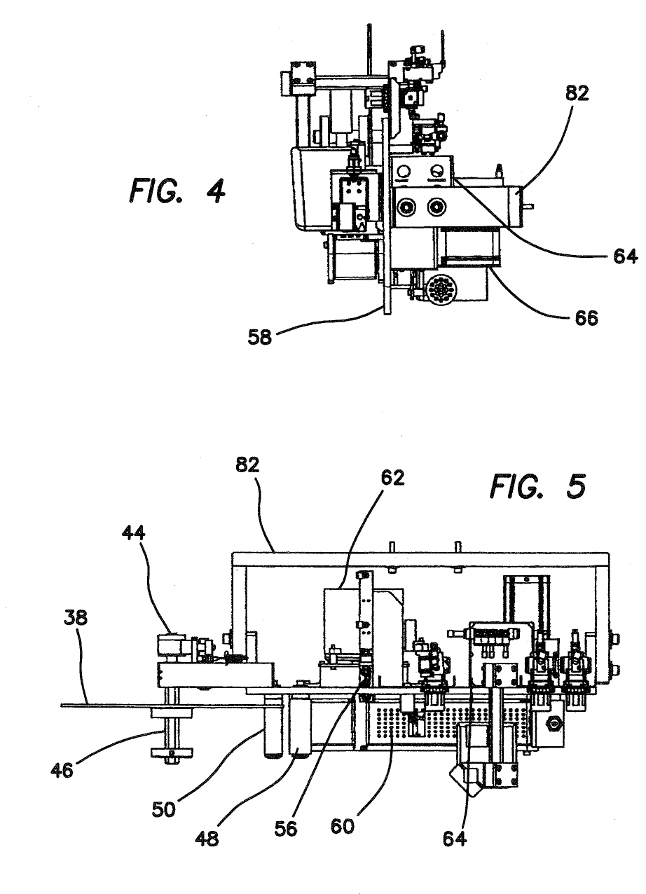

Now, with reference to FIGS. 1-5, the liner-less label applicator 14 will be described in greater detail. The applicator 14 comprises a label dispenser, preferably an unwind assembly 36 having an unwind disk 38 on which is carried a roll of labels 40 for application to the passing articles 22 on the conveyor 18, which moves in a direction indicated by an arrow 42. The unwind assembly 36 is comprised of the aforementioned assembly unwind disk 38, as well as an assembly unwind drive mechanism 44, with brake, and a shaft or spindle 46 for accommodating the roll of labels 40. The unwind assembly 36 is rotatably driven through the assembly unwind drive mechanism 44.

The labels 40 preferably comprise a continuous length of transparent adhesive tape, having an adhesive surface and a silicon release coating on the non-adhesive surface of the tape. In one particular embodiment, the tape comprises Danco 264 Security tape having specifications of 1300 m×60 mm×30 micron×3″ core, though other suitable adhesive tapes can be used, as long as they meet appropriate or required specifications for the intended application.

Security tape 40 unwinding from the unwind assembly 36 is routed about idler rollers 48 and 50 along a feedpath to a vacuum belt drive unit 52. The idler roller 48 is preferably rubber coated, while the idler roller 50 is preferably plasma coated. The vacuum belt drive unit 52 comprises a drive belt 54 on which the security tape is conveyed, toward a rotary blade cutter assembly 56, which is disposed on a faceplate 58 The vacuum belt drive unit 52 further comprises a vacuum grid assembly 60 and a vacuum grid belt assembly blower 62. The label feedpath is directed onto the vacuum grid assembly 60, which comprises a plurality of vacuum fans disposed beneath the vacuum drive belt 54 for receiving and retaining the label tape 40 thereon.

Within a control box or enclosure 64 are disposed the electrical controls and processor necessary to operate the system. These controls are, generally speaking, typical in the industry and will not be further described herein, except with respect to specific programming for the processor. The main drive 66 for the vacuum belt drive unit 52 is disposed on the back of the faceplate 58 as well. Other components of note in the inventive system include an ionizer 68 and having an associated static eliminator nozzle 70, a print head 72, which is attached to the faceplate 58 via a print head assembly 73, and a perforator device 74, each of which are mounted on the faceplate 58. A peeling edge 76 also comprises a sensor plate at the end of the vacuum belt 54. A pneumatic assembly 78 having four pneumatic stations or connections 80 is also provided. A U-arm 82 provides a structural framework for the system. Known printing units, such as the 5800 or 5200 models offered by Markem Corporation, may be used.

In operation, an operator activates the label application system by actuation of an appropriate control switch on the operator control box 64. Once operational, the roll of security tape 40 is unwound from the unwind assembly 36, so that a length of the tape 40 travels along the feedpath of the device, about idler rollers 48 and 50. As a result, a leading edge of the tape enters onto the vacuum belt drive unit 52. The tape 40 is advanced to the vacuum grid assembly 60, with the adhesive side up, the tape being retained on the vacuum drive belt 54 because of perforations in the belt, and continued operation of the underlying vacuum fans. Additionally, the upper surface of the vacuum belt is preferably comprised of a high friction surface in order to assist in holding the tape in position. The system accepts articles 22 from the accumulating conveyor 20 via the gate 24. Articles 22 are presented end on so that the main panel, i.e. the end panel 84 of the article, leads. This panel 84 already has a label (not shown) displaying the product/weight and a barcode which includes field defining information, product details, carton size, type, and the like.

Focusing primarily, once again, on the liner-less applicator 14 portion of the system, the system processor 64 is programmed to generate a real time seal, the serial number of which is data-matched with the product label data, read from the product label on panel 84 by the first barcode reader 28, and transmitted to the controller for processing. The image is printed in the required position (to suit that article) onto the adhesive surface of the seal tape 40, by the print head 72. The reason for printing the image on the adhesive side of the tape is to thereby encapsulate the printed image to prevent tampering. The rubber coated idler roller 48 incorporates a one-way bearing. The bearing and the rubber roller overcomes the pull from the unwind assembly 36, which prevents the tape from running backwards. The plasma coated idler roller 50 provides a high release surface, where the tape adhesive side contacts it. The vacuum drive belt 54 has three vacuum sections. The high-vacuum sections are adjacent to the cutter 56 and a low-vacuum section is just below the print head 72. The vacuum sections are used to pull the tape against the high friction endless belt 54. This action generates a friction force to un-spool the tape, to hold down the tape during the cutting action, and to present a flat-smooth surface while the seal is printed. In combination with the one-way idler roller 48, the high and low pressure vacuum zones provide forward motion control for the tape. The real-time seal is printed while the belt drive indexes the tape, and the cutting action is done by cutter 56 while the system collects data and the belt drive is stationary. The cutting step only cuts the tape approximately ¾ of its width. There is only one stepper motor employed to drive the vacuum belt. The vacuum belt drive pulls the tape from the unwind assembly and feeds the tape through the print head 72 and onto a label carrier or vacuum drum applicator 86 (FIG. 1). Label carriers of this vacuum drum applicator type are known, one such label carrier being disclosed and described in commonly assigned U.S. Pat. No. 5,645,669, which is herein expressly incorporated by reference. The perforator device 74 bursts perforation across the round element of the seal image. This is to apply a weak point on which the seal will break if tampered with.

As noted above, the required tape length is fed from the liner-less applicator out onto the vacuum drum applicator 86, which comprises a vacuum drum 88, that is rotatably mounted to and carried by the end of a hinged arm 90. The hinged arm 90 is pivotally attached at its opposing end 92 to the liner-less label applicator 14. Maneuvering of the hinged arm 90 of the vacuum drum unit 86 causes the vacuum drum applicator or label carrier 88, on which the label 40 is disposed, to contact the center of the leading end 84 of the article 22. The seal tape 40 is laid onto the surface with moderate pressure, to achieve a viable bond of the adhesive in the article surface fibers. The gate unit 24 allows an article 22 onto the main conveyor 18, which in turn transfers the article 22 through the system at a higher speed than the accumulating conveyor 20. This generates a gap between articles at the accumulating conveyor, allowing scanning of the data label on the article end panel 84 with the first barcode reader 28. The vacuum drum applicator 88 wipes the tape 40 around the end and top panels of the article, and a roller device wipes the label around the bottom corner of the article 22. The sealed article travels through the machine and exits. The tape printed information is verified by the second barcode reader 30 while the article exits the system.

While this invention has been described with respect to various specific examples and embodiments, it is to be understood that various modifications may be made without departing from the scope thereof. Therefore, the above description should not be construed as limiting the invention, but merely as an exemplification of preferred embodiments thereof and that the invention can be variously practiced within the scope of the following claims.

What is claimed is:

1. A label application system for applying liner-less labels comprising adhesive tape to passing articles on a conveyor, comprising:
a dispenser for dispensing adhesive tape;
a vacuum drive belt unit comprising a drive belt onto which the adhesive tape dispensed by the dispenser is received and retained, the adhesive tape being received onto the drive belt so that its non adhesive side contacts the drive belt and its adhesive side faces up, the adhesive tape being retained on the drive belt by vacuum fans beneath the drive belt;
a print head for printing information on the adhesive side of the tape as it passes adjacent to the print head;
a cutter for cutting the tape; and
an applicator for applying the printed, cut portion of tape onto an article passing on the conveyor.

2. The label application system as recited in claim 1, and further comprising a controller having a processor for determining the information to be printed on the tape, wherein said information comprises a real-time seal to ensure that the passing article is tamper-proof

3. The label application system as recited in claim 2, and further comprising a reader located adjacent to the applicator, for reading product labels on articles as they approach the applicator on the conveyor, and transmitting the read information on the product labels to the processor.

4. The label application system as recited in claim 3, wherein the reader comprises a barcode reader.

5. The label application system as recited in claim 1, and further comprising a perforator for perforating or delaminating the tape in the printed area, thereby weakening the tape to cause the printed portion of the tape to break if tampered with.

6. The label application system as recited in claim 1, wherein the vacuum drive belt comprises a relatively high vacuum section and a relatively low vacuum section, for providing forward control of the tape along its feedpath.

7. The label application system as recited in claim 6, wherein the relatively high vacuum section on the vacuum drive belt is adjacent to the cutter, and the relatively low vacuum section on the vacuum drive belt is adjacent to the print head.

8. The label application system as recited in claim 3, and further comprising a second reader downstream of said reader, for verifying that the information printed on the tape disposed on a passing article matches the information on the product label disposed on the same article.

9. The label application system as recited in claim 1, and further comprising wipers for ensuring that the printed, cut portion of tape is applied securely to multiple sides of the passing article.

10. A label application system for applying liner-less security seals comprising adhesive tape to passing articles on a conveyor, comprising:
a dispenser for dispensing adhesive tape;
a drive belt onto which the adhesive tape dispensed by the dispenser is received and retained, the adhesive tape being received onto the drive belt so that its non adhesive side contacts the drive belt and its adhesive side faces up;
a controller having a processor for directing the operation of the system;
a reader adjacent to the conveyor for reading a product label disposed on a face of an article to be sealed, and transmitting the read information to the processor;
a print head for printing information on the adhesive side of the tape as it passes adjacent to the print head;
a cutter for cutting the tape; and
an applicator for applying the printed, cut portion of tape onto an article passing on the conveyor.

11. The label application system as recited in claim 10, wherein the information applied by the print head onto the tape is received from the processor and derived from the information read by the reader from the product label.

12. The label application system as recited in claim 10, wherein the applicator comprises a vacuum drum applicator.

13. The label application system as recited in claim 10, wherein the reader comprises a barcode reader.

14. The label application system as recited in claim 10, and further comprising a perforator for perforating or delaminating the tape in the printed area, thereby weakening the tape to cause the printed portion of the tape to break if tampered with.

15. The label application system as recited in claim 10, and further comprising a second reader downstream of said reader, for verifying that the information printed on the tape disposed on a passing article matches the information on the product label disposed on the same article.

16. A method of applying tamper-resistant seals to passing articles, comprising:
advancing a length of adhesive tape along a feedpath onto a vacuum drive belt, the tape having an adhesive side and a non-adhesive side, wherein the adhesive side contacts the vacuum drive belt and the non-adhesive side faces upwardly;
reading information contained on a product label disposed on an article approaching a seal applicator and transmitting that information to a processor;
using the information from the product label obtained by the reading step to cause the processor to generate information specific to the approaching article and to transmit that information to a print-head;
using the print head to apply the specific information generated by the processor to a portion of the adhesive side of the tape as it passes adjacent to the print head;
cutting the printed portion of the tape from a remaining length of tape, and feeding the cut portion to an applicator; and
applying the cut and printed portion of the tape to the approaching article.

17. The method as recited in claim 16, and further comprising a step of perforating portions of the cut and printed portion of tape, on its printed region, to weaken it so that any tampering with the seal will cause the seal to break and thus comprise visible evidence of the tampering.

18. The method as recited in claim 16, and further comprising a step of applying differential levels of vacuum pressure to different regions of the vacuum drive belt to assist in moving the tape forwardly along the drive belt.

19. The method as recited in claim 18, wherein the differential levels of vacuum pressure applying step further comprises applying a relatively high level of vacuum pressure adjacent to a cutter for performing the cutting step and applying a relatively low level of vacuum pressure adjacent to the print head.

20. The method as recited in claim 16, and further comprising a step of reading the information applied to the seal by the print head after the sealed article has passed further downstream on the conveyor, and transmitting the read information to the processor to ensure that it matches the information originally read on the product label during the first reading step.
